(19) United States
(12) Patent Application Publication
(10) Pub. No.: US 2010/0248828 A1
(43) Pub. Date: Sep. 30, 2010

(54) Educational toy

(76) Inventor: Ty Huynh Kaing, La Puente, CA (US)

Correspondence Address: DAVID AND RAYMOND PATENT FIRM, 108 N. YNEZ AVE., SUITE 128, MONTEREY PARK, CA, 91754, US

(21) Appl. No.: 12/383,530

(22) Filed: Mar. 24, 2009

(51) Int. Cl. G09B 5/06

(52) U.S. Cl. 463/31

(57) ABSTRACT

An educational toy for toddler and preschool child includes an electronic device and a toy body, wherein the electronic device includes an activator, a power source, a feedback storage, and a feedback output device. The electronic device is incorporated with the toy body, so that when the electronic device is activated by an interaction between the educational toy and the toddler, a feedback is outputted from the feedback storage to the feedback output device, so as to output the feedback auditory and visually, in such manner that the educational toy can effectively seize the children's golden time of learning.

### BACKGROUND OF THE PRESENT INVENTION

1. Field of Invention

The present invention relates to an educational toy for children, and more particularly to an educational toy for toddler or preschool child, which is provided for educating the children through an interactive between a playing movement of the educational toy and the toddler.

2. Description of Related Arts

Preschool education is very important that studies show learning the fundamentals such as colors, numbers, and shapes before the preschool or elementary school can enhance the formal education and excite the willingness to learn of the children. Normally a kid does not begin an education process until preschool or even elementary school. Thus, the children will lose the most precious years learning.

Other studies also indicate that preschool education can help to inspire the potential intelligent of the children and excite the interests of that field. For instance, if a kid starts listening to music at his/her early age, the kid usually have relatively higher talent of music. If a child starts learning a different language, they will be interested in learning more about the language and culture. The learning region of the brain is constantly developing and changing, which means, embedding another language through voice identification and voice recognition is very important. Once the child develops these skills, it will enhance and inspire them to learn and appreciated the language of other cultures.

Preschool education is usually through interactions between instructors and the children. The instructors, such as the parents, or nursemaid, teach the children the fundamentals and skills through playtime with the children. Through these interactions of playing, teaching, listening, or touching, the children learn the basic skills and knowledge before their formal education.

However, parents usually have very limited time to educate their children before preschool. After a busy day of work or changing diapers, feeding, showering or bathing the kid, the time remaining for educating the kid is not enough to prepare them for their future education. For the parents who have time to spend with their child for the educational activities, it is difficult to draw the attention of the child and be focused on the task at hand.

There are many toys designed for educating kids while they are having fun, but most are too technologically advanced for toddlers. Young toddlers have short attention span, which means an educational toy mush have visual and audio output to keep the child's attention. They enjoy pushing, chasing, or hugging their toys.

However, those educational toys tend to have only one way of learning, so that the toys can not match the different requirements for the preschool education. For example, some children learn more efficiency by listening, others may learn better through visual method. Most of the children sufficiently learn through the combination ways of auditory, and visual, etc.

Thus, there exists a need for providing an educational toy for children, which can teach and grab the attention of children, and audibly and visually output information from the educational toy.

### SUMMARY OF THE PRESENT INVENTION

A main object of the present invention is to provide an educational toy for toddler or preschool child, especially for toddlers or preschool children, wherein through playing with the educational toy, the child will be able to activate the educational toy to output a feedback, so as to gain the knowledge therefrom.

Another object of the present invention is to provide an educational toy for toddler or preschool child, wherein the children can easily learn by a subconscious education through the educational toy.

Another object of the present invention is to provide an educational toy for the toddler or preschool child, wherein the educational toy is being activated through an interaction between the children and the educational toy, such that the educational toy can draw the attention of the children so as to stimulate their interest in learning. In other words, the interactive response of the playing movement can keep the toddler mentally stimulated in an activity he or she naturally enjoys.

Another object of the present invention is to provide an educational toy for toddler or preschool child, wherein the interactive response of the playing movement is adapted to hold the toddler attention so as to help the toddler to develop muscle tone, agility and stamina.

Another object of the present invention is to provide an educational toy for the toddler or preschool child, wherein at least one feedback output method is provided for outputting the feedback information, so that the toddler learns the knowledge through a way of subliminal learning.

Another object of the present invention is to provide an educational toy for the toddler or preschool child, wherein the feedback comprises a plurality of general knowledge, a plurality of languages, a plurality of arts, and a plurality of sciences.

Another object of the present invention is to provide an educational toy for the toddler or preschool child, wherein the educational toy is activated by an interaction of pushing, touching, rotating the educational toy, or the like.

Another object of the present invention is to provide an educational toy for the toddler or preschool child, wherein the educational toy outputs the information of the knowledge to allow the children, especially the preschool children, learn through their subconscious, so as to seize the golden learning period to sufficiently enhance the preschool education.

Accordingly, in order to accomplish the above objects, an educational toy of the present invention is provided, wherein the educational toy comprises an electronic device and a toy body, wherein the electronic device comprises an activator for activating the educational toy, a power source for supplying power to the educational toy, a feedback storage for storing information of one or more AV feedbacks, and a feedback output device for outputting the feedbacks.

The toy body has a compartment for receiving the power source of the electronic device, wherein the toy body is provided for integrally incorporation with the electronic device, so that when the activator is activated to activate the educational toy, a feedback is outputted through the feedback output device. In such a manner that the children learn from the feedback output device while they are playing with the educational toy.

In addition, the present invention further provides a method of operating an educational toy for an education purpose, wherein the method comprises the steps of the followings:

(a) activating an electronic device of an educational toy by the interactions between the children and the educational toy; and

(b) outputting a feedback from a feedback output device after activating the electronic device, so as to educate the children through the feedbacks from the feedback output device.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an educational toy, according to a preferred embodiment of the present invention.

FIG. 2 is a block diagram of the educational toy according to the above preferred embodiment of the present invention, illustrating a plurality of components of an electronic device of the educational toy.

FIG. 3 is a perspective view of an educational toy according to an alternative mode of the above preferred embodiment of the present invention.

FIG. 4 is an exploded perspective view of the educational toy according to the alternative mode of the above preferred embodiment of the present invention.

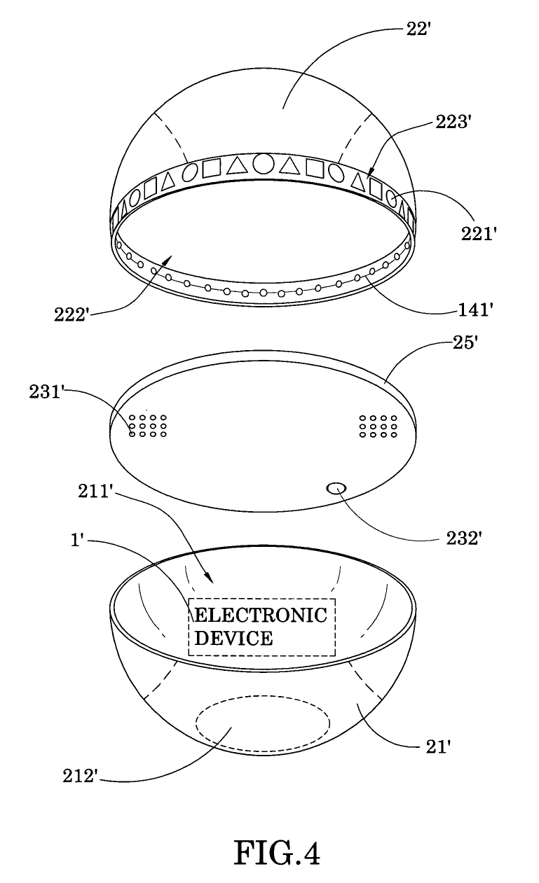

FIG. 5 is a block diagram of the electronic device of the educational toy according to the alternative mode of the above preferred embodiment of the present invention.

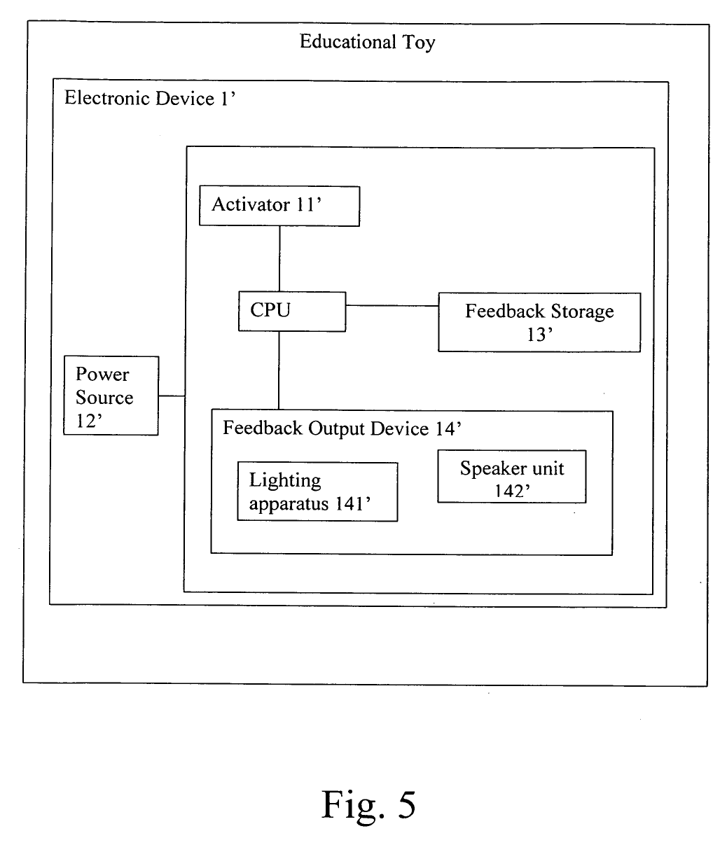

FIG. 6 is a sectional view of an alternative toy body of the educational toy according to the alternative mode of the above preferred embodiment of the present invention.

FIG. 7 is an exploded perspective view of the educational toy according to a third preferred embodiment of the present invention.

FIG. 8 is a sectional view of the educational toy according to the third preferred embodiment of the present invention.

FIG. 9 is a block diagram of the electronic device of the educational toy according to the third preferred embodiment of the present invention.

FIG. 10 is a sectional view of the educational toy according to a fourth preferred embodiment of the present invention.

FIG. 11 is a block diagram of the electronic device of the educational toy according to the fourth preferred embodiment of the present invention.

### DETAILED DESCRIPTION OF THE PREFERRED EMBODIMENT

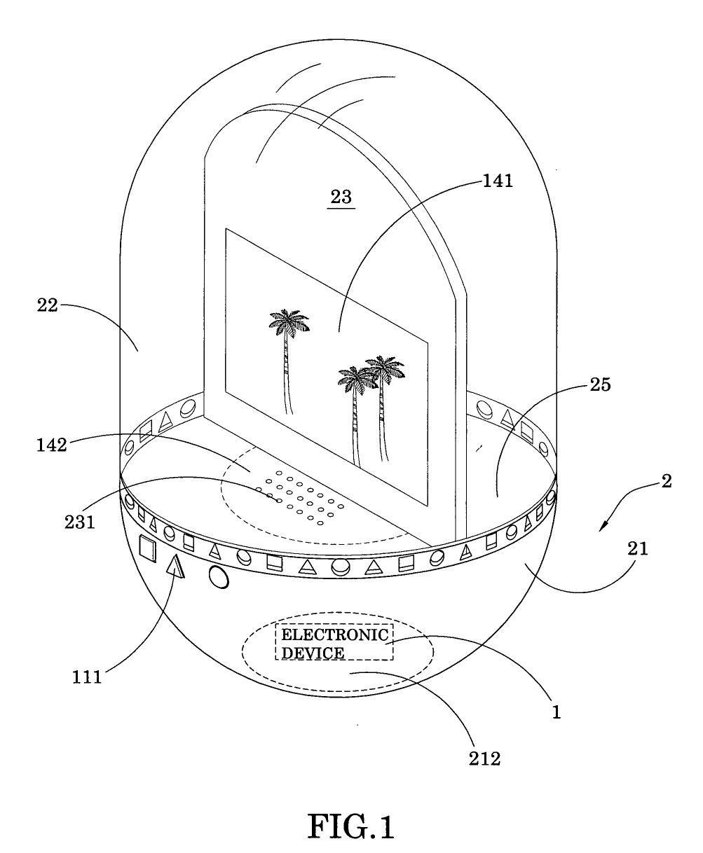

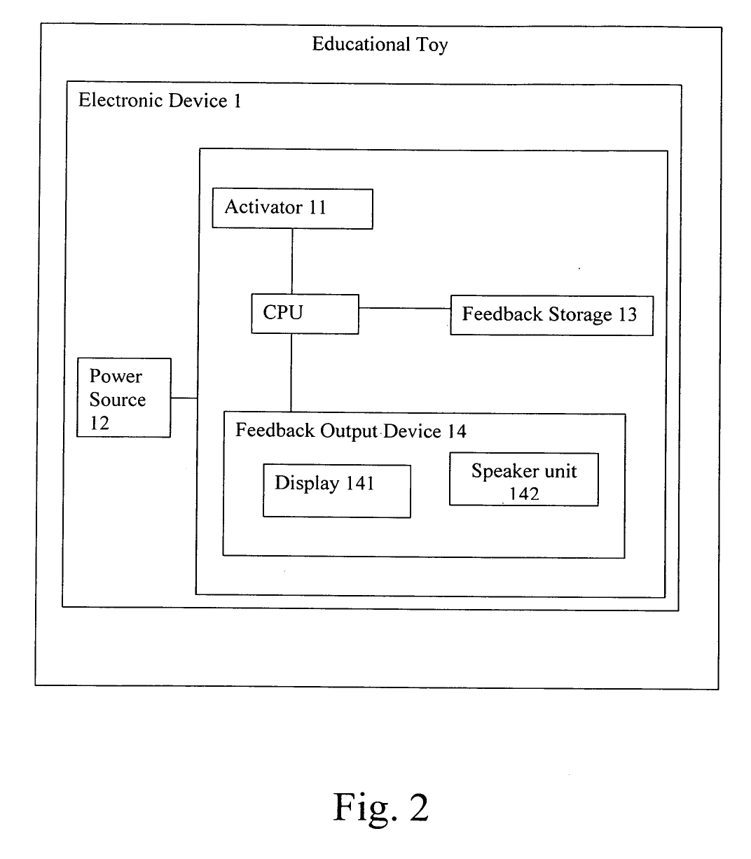

Referring to FIGS. 1 and 2 of the drawings, an educational toy according to a preferred embodiment of the present invention is illustrated, wherein the educational toy comprises an electronic device 1 and a toy body 2. The electronic device 1 comprises an activator 11, a power source 12 to provide a power for the electronic device 1, a feedback storage 13, and an feedback output device 14 comprising a visual output device for generating a visual feedback and an auditory output device for generating an auditory feedback.

The toy body 2 comprises a bottom housing 21 for housing the electronic device 1 therein, an upper transparent cover 22 mounted on the bottom housing 21 for the visual feedback being seen through the transparent cover 22, and a utility panel 25 supported at a position to partition between the bottom housing 21 and the transparent cover 22. The toy body 2 has a compartment provided at the bottom housing 21 for receiving and enclosing the electronic device 1 therein. Accordingly, the visual output device supports on the utility panel 25 and faces towards the transparent cover 22.

The feedback output device 14, which is provided for outputting the AV feedback, such as information of art, science, general knowledge, common sense, or language, comprises a display 141 of visual output device for outputting the visual feedback, and a speaker unit 142 of auditory output device provided for outputting the auditory feedback. The display 141 is supported on a utility surface 23 of the toy body 2 and electrically connected to the electronic device 1, wherein the speaker unit 142 of the electronic device is received within the compartment 21 of the toy body 2.

The transparent cover 22 is arranged for covering the display 141, wherein the transparent cover 22 has a bottom opening having a approximate round shape corresponding to a size and a shape of the top peripheral edge of the bottom housing 21, so that the transparent cover 22 is mounted on the top peripheral edge of the bottom housing 21 of the toy body 2 through the bottom opening of the transparent cover 22. In other words, the transparent cover 22 is provided to cover and protect the display 141 therewith, so as to form an egg-like shape educational toy.

As shown in FIG. 1, the utility surface 23 is perpendicularly and upwardly extended from the utility panel 25 within the transparent cover 22 such that the visual feedback is adapted for being seen through the transparent cover 22 of the toy body 2 to interact with the auditory feedback.

A plurality of sound holes 231 is provided at the bottom housing 21, wherein the sound holes 231 are aligned with the speaker unit 142 for the audio information, such as music, sound and speaking, broadcasting to outside via the sound holes 231. Thus, when the activator 11 is triggered through an interaction between the children and the educational toy to activate the feedback storage 13 outputting the feedback, the feedback is outputted through the feedback output device 14 for being audibly and/or visually received by the children.

Accordingly, the visual feedback is a visual image selected from the group consisting of picture, still image, moving image, and light effect, wherein the auditory feedback is a voice effect to describe the visual image. In other words, the feedback is information of science, art, languages, or general knowledge of common sense, such as colors, numbers, shapes, so that the educational toy can educate the children while they are playing with the educational toy.

The interaction between the children and the educational toy (such as a movement, rotating, swinging, pressing a button of the educational toy, pushing, or touching) activates the activator 11 of the electronic device of the educational toy, and thus the educational toy outputs a feedback such as the information of science, art, general knowledge, common sense, or language for educating and/or drawing the interest of the children. Accordingly, the activator 11 comprises motion sensor disposed within the bottom housing 21 of the toy body 2 for detecting the playing movement of the toy body 2 so as to activate the feedback output device.

It is appreciated that children, especially the toddler or preschool child, can easily learn through subconscious. Through the interaction between the children and the educational toy, the children subconsciously learn from the feedback and let the feedback, such as color, number, pronunciation, music, or painting, into the subconscious of the children, so as to improve an ability and motivation for the children entering the formal education process such as elementary school or kindergarten.

An outer shape of the bottom of the toy body 2 has a proximately bowl shape with the compartment built therein. In addition to the bowl shape of the bottom of the toy body 2, a weight member 212 is disposed at the bottom of the compartment of the bottom housing 21 to provide a center of gravity, so that the educational toy can be standing still after being pushed as a roly-poly tumbler. It is worth to mention that the display 141 and the speaker unit 142 of the electronic device I should be supported along a centerline of the toy body 2 to align with the weight member 212 such that the toy body 2 is adapted to provide the tumbler movement by a push of the toddler.

Due to the tumbler function provided by the weight member 212 of the educational toy, when the children push the educational toy, the educational toy detects the movement and is triggered to output a feedback and swings back by a counterforce from the push of the children, so as to draw the curiosity and interest of the children.

The electronic device 1 of the educational toy further comprises a plurality of selection buttons 111 provided at the toy body 2 to electrically link with the feedback output device for selecting one of said learning information of the AV feedback to be output. Accordingly, the selection buttons 111 are spacedly formed at the bottom housing 21 of the toy body 2, wherein each of the selection buttons 111 is electrically linked to the information storage 13 of the electronic device 1 through a processor. Each of the selection buttons 111 has different modes linked to the different types of feedback stored at the feedback storage 13. The selection buttons 111 are respectively linked to the feedbacks of an art information, a science information, a common sense information, a general knowledge information, and a language information having at least one language, so that when the children press one of the selection buttons 111, the different types of feedbacks will be outputted respectively.

For instance, when the selection button 111 is pressed to trigger the feedback of art information, one of the random arts, such as a painting of a master piece, is popped out to show up an image of the painting on the display 141, and a brief story of the painting is outputted through the speaker unit 142 of the feedback output device 14. Take music as another example of the art feedback, when the selection button 111 is pressed to trigger the feedback of art information, one of the random songs is being played through the speaker unit 142, and an image of the composer of this song shows on the display 141.

An example of a feedback would be the scientific information. When the selection button 111 is pushed, a random scientific fact, such as an image of the earth will appear on the display 141, wherein a brief auditory description about earth is outputted through the speaker unit 142 at the same time.

Another example is the general knowledge, wherein when the selection button 111 is pressed to activate the general knowledge feedback, one of the colors and shapes is popped out on the display 141. For instance, a red triangle is popped out on the display 141 when the auditory information of “red triangle” is outputted through the speaker unit 142.

The educational toy is preferred to be activated by the interaction of pushing, touching, rotating, moving the educational toy, or pressing the selection buttons 111 of the educational toy to activate the activator 11 of the electronic device 1 of the educational toy, so that when the educational toy is being pushed, touched, rotated, pressed, or moved, the information stored at the feedback storage 13 is visually and/or audibly outputted through the feedback output device 14.

The visual feedback outputted from the display 141 of the feedback output device 14 is corresponding to the auditory feedback outputted from the speaker unit 142 of the feedback output device 14. One of the random feedbacks that triggered by one of the interaction is popping out a creature, such as “fish”, and shows a fish on the display 141 of the feedback output device 14, and a voice “fish” is outputted from the speaker unit 142 of the feedback output device 14, in such a manner that the output feedback of corresponding visual and auditory information educates the children a common sense or general knowledge.

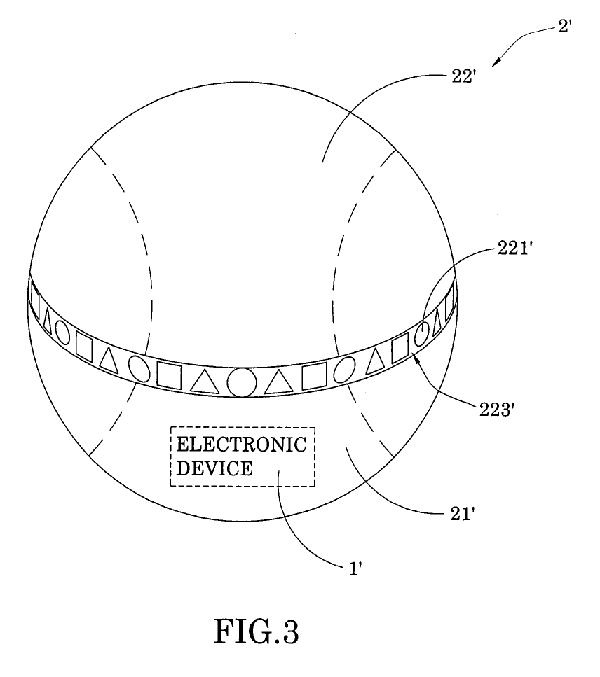

Referring to FIG. 3 of the drawings, an educational toy of a second preferred embodiment of the present invention is illustrated, wherein the educational toy comprises an electronic device 1′ and a toy body 2′, wherein the electronic device 1′ comprises an activator 11′, a power source 12′ to provide a power for the electronic device 1′, a feedback storage 13′ storing the feedbacks information, and an feedback output device 14′ comprising a visual output device and an auditory output device. The feedback output device 14′ further comprises a lighting apparatus 141′ of the visual output device and a speaker unit 142′ of the auditory output device electrically connected to the feedback storage 13′ through a processor of the electronic device 1′.

The toy body 2′ having an approximate hollow ball shape comprises a bottom housing 21′ and an upper transparent cover 22′, wherein the bottom housing 21′ has an approximate hollow half ball shape to define a first compartment 211′ therewithin, wherein a bottom of the bottom housing 21′ has a small flat surface provided for standing the educational toy on a surface such as floor or table. The transparent cover 22′ of the toy body 2′ has an approximate hollow half ball shape to define a second compartment 222′ therewithin, wherein the transparent cover 22′ has an approximate identical shape of the bottom housing 21′, so that the bottom housing 21′ and the transparent cover 22′ of the toy body 2′ are mounted together to form the hollow ball shape of the toy body 2′.

A utility panel 25′ is further provided between the bottom housing 21′ and the transparent cover 22′ of the educational toy as a partition for covering the compartment 211′ within the bottom housing 21′. The bottom housing 21′ of the toy body 2′ has a first opening, and the transparent cover 22′ of the toy body 2′ has a second opening, wherein the utility panel 25′, which has a circumference slightly smaller than a circumference of the first opening of the bottom housing 21′, is mounted at an inner peripheral edge of the bottom housing 21′ to cover the compartment 211′ of the bottom housing 21′ and to form a half ball shape, so as to cover the electronic device 1′ provided within the first compartment 211′ of the bottom housing 21′.

The electronic device 1′ is supported within the first compartment 211′, wherein the transparent cover 22′ is further mounted with a peripheral edge of the first opening of the bottom housing 21′ through a peripheral edge of the second opening of the bottom housing 21′, so that the approximate hollow ball shape of the toy body 2′ is formed. In order words, the transparent cover 22′ is sandwiching the utility panel 25′ between the bottom housing 21′ and the transparent cover 22′.

The utility panel 25′ further has a plurality of sound holes 231′ and a utility hole 232′ provided thereat, wherein the sound holes 231′ are provided to align with the speaker unit 142′ for the audio information, broadcasting to outside via the sound holes 231′. The utility hole 232′ is provided for a wire, which is adapted for electrically connecting the lighting apparatus 141′ to the CPU of the electronic device 1′, to go through the utility hole 232′ from the first compartment 211′ to the second compartment 222′.

The transparent cover 22′ of the toy body 2′ further has a plurality of cavities 221′ provided at the peripheral edge of the second opening of the transparent cover 22′, wherein the cavities 221′ have different shapes such as triangle, square, and circle. A strip 223′ is provided at an outer peripheral edge of second opening of the transparent cover 22′ for covering the cavities 221′ at the peripheral edge of the second opening of the transparent cover 22′, wherein the strip made by a transparent or semi-transparent material is provided for covering the cavities 221′ of the transparent cover 22′.

The lighting apparatus 141′ is provided at an inner peripheral edge of the transparent cover 22′ and within the second compartment 222′ of the transparent cover 22′, wherein the lighting apparatus 141′ is electrically connected to the CPU of the electronic device 1′ by the wire, which goes through the utility hole 232′ of the utility panel 25′ to connect the CPU of the electronic device 1′ and the lighting apparatus 141′. The lighting apparatus 141′ comprises a plurality of LEDs provided at an inner peripheral edge of the opening of the transparent cover 22′ to align with the cavities 221′ at the peripheral edge of the transparent cover 22′, so that when the activator 11′ of the electronic device 1′ of the educational toy is being triggered, the LEDs of the lighting apparatus 141′ are turned on to emit a light beam generated from the LEDs from the cavities 221′.

The activator 11′ of the electronic device 1′ is being triggered by the interaction between the children and the educational toy, wherein the interaction is a movement of the educational toy, such as rotating, pushing, moving, shaking, touching, or swinging, so that when the educational toy is triggered by the movement of the interaction, the feedback storage 13′ is activated to output the feedback through the feedback output device 14′. For instance, when the educational toy is triggered by a pushing of the children, the LEDs which are aligned with the cavities 221′ of the triangle shape are lightened, wherein a voice “triangle” is outputted through the speaker unit 142′ of the feedback output device 14′, so that the children see the triangle shape and hear the corresponding voice “triangle” at the same time, in such a manner that the children can learn the common sense of shapes.

A weight member 212′ is further provided at the bottom of the first compartment 21′ of the bottom housing 21′ as a center of gravity, so that the educational toy can be standing still after being pushed as a roly-poly tumbler.

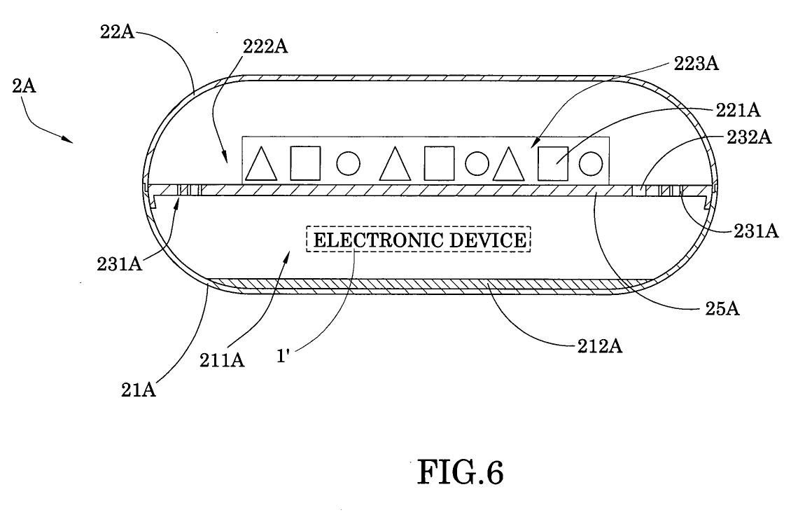

Referring to FIG. 6 of the drawings, an alternative toy body 2A of the educational toy according to the second preferred embodiment of the present invention is illustrated, wherein the toy body 2A having a hollow capsule shape comprises a bottom housing 21A and an upper transparent cover 22A, wherein the bottom housing 21A has an approximate hollow half longitude capsule shape to define a first compartment 211A therewithin. The transparent cover 22A of the toy body 2A has an approximate hollow half longitude capsule shape to define a second compartment 222A therewithin, wherein the transparent cover 22A has an approximate identical shape of the bottom housing 21A.

The bottom housing 21A has a top opening to define the first compartment 211A within bottom housing 21A and the transparent cover 22A has a bottom opening to define the second compartment 222A within the transparent cover 22A, so that the bottom housing 21A and the transparent cover 22A of the toy body 2A are mounted together through the first and second opening to form the hollow capsule shape of the toy body 2A.

A utility panel 25A is further provided between the bottom housing 21A and the transparent cover 22A of the educational toy for covering the compartment 211A within the bottom housing 21A. The bottom housing 21A of the toy body 2A has a first opening, and the transparent cover 22A of the toy body 2A has a second opening, wherein the utility panel 25A, which has a circumference slightly smaller than a circumference of the first opening of the bottom housing 21A, is mounted at an inner peripheral edge of the bottom housing 21A to entirely cover the compartment 211A of the bottom housing 21A and to form a half longitude capsule shape, so as to cover the electronic device 1′ provided within the first compartment 211A of the bottom housing 21A

The electronic device 1′ is provided within the first compartment 211A of the bottom housing 21A, wherein the transparent cover 22A is further mounted with a peripheral edge of the first opening of the bottom housing 21A through a peripheral edge of the second opening of the bottom housing 21A, so that the hollow capsule shape of the toy body 2A is formed. In order words, the transparent cover 22A is sandwiching the utility panel 25A between the bottom housing 21A and the transparent cover 22A.

The utility panel 25A further has a plurality of sound holes 231A and a utility hole 232A provided thereat, wherein the sound holes 231A are provided to align with the speaker unit 142′ for the audio information, broadcasting to outside via the sound holes 231A. The utility hole 232A is provided for a wire, which is adapted for electrically connecting the lighting apparatus 141′ to the CPU of the electronic device 1′, to go through the utility hole 232A from the first compartment 211A to the second compartment 222A.

The transparent cover 22A of the toy body 2A further has a plurality of cavities 221A provided at the peripheral edge of the second opening of the transparent cover 22A, wherein the cavities 221A have different shapes such as triangle, square, and circle. A strip 223A is provided at an outer peripheral edge of second opening of the transparent cover 22A for covering the cavities 221A at the peripheral edge of the second opening of the transparent cover 22A, wherein the strip made by a transparent or semi-transparent material is provided for covering the cavities 221A of the transparent cover 22A.

The lighting apparatus 141′ is provided at an inner peripheral edge of the transparent cover 22A, wherein the lighting apparatus 141′ is electrically connected to the CPU of the electronic device 1′ by the wire, which goes through the utility hole 232′ of the utility panel 25A to connect the CPU of the electronic device 1′ and the lighting apparatus 141′. The lighting apparatus 141′ comprises a plurality of LEDs provided at an inner peripheral edge of the opening of the transparent cover 22A to align with the cavities 221A at the peripheral edge of the transparent cover 22A, so that when the activator 11′ of the electronic device 1′ of the educational toy is being triggered, the LEDs of the lighting apparatus 141′ are turned on to emit a light beam generated from the LEDs from the cavities 221A.

The activator 11′ of the electronic device 1′ is being triggered by the interaction between the children and the educational toy, wherein the interaction is a movement of the educational toy, such as rotating, pushing, moving, shaking, touching, or swinging, so that when the educational toy is triggered by the movement of the interaction, the feedback storage 13′ is activated to output the feedback through the feedback output device 14′. For instance, when the educational toy is triggered by push from the children, the LEDs which are aligned with the cavities 221A of the triangle shape are lightened, wherein a voice “triangle” is outputted through the speaker unit 142′ of the feedback output device 14′, so that the children see the triangle shape and hear the corresponding voice “triangle” at the same time, in such a manner that the children can learn the common sense of shapes.

A weight member 212A is further longitude provided at the bottom of the first compartment 211A of the bottom housing 21A as a center of gravity, so that the educational toy can be standing still after being pushed as a roly-poly tumbler.

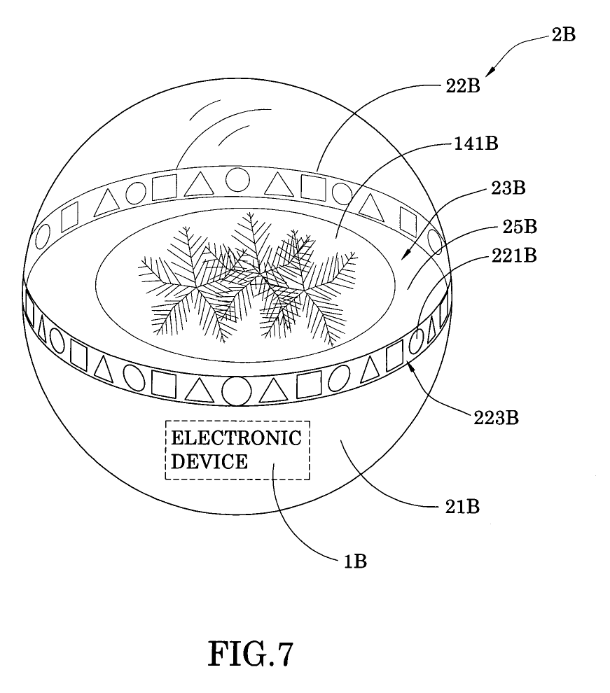

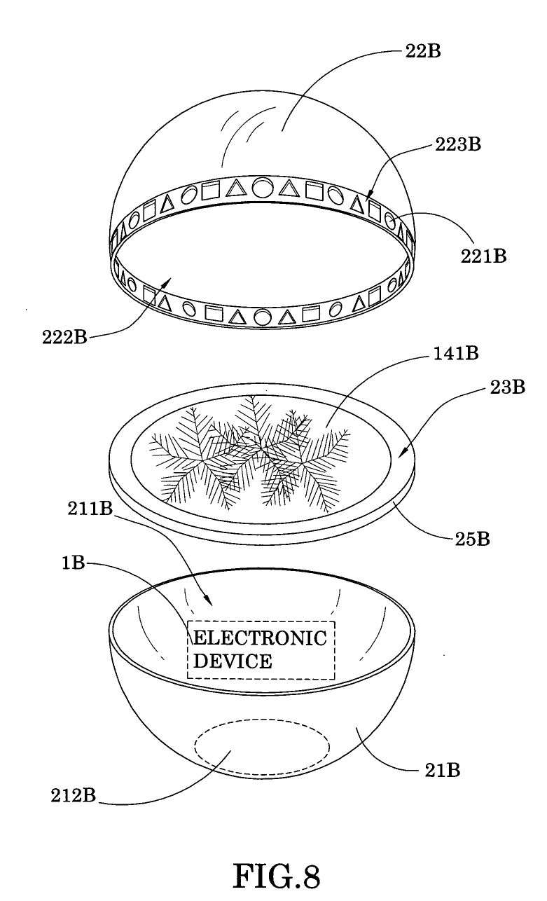

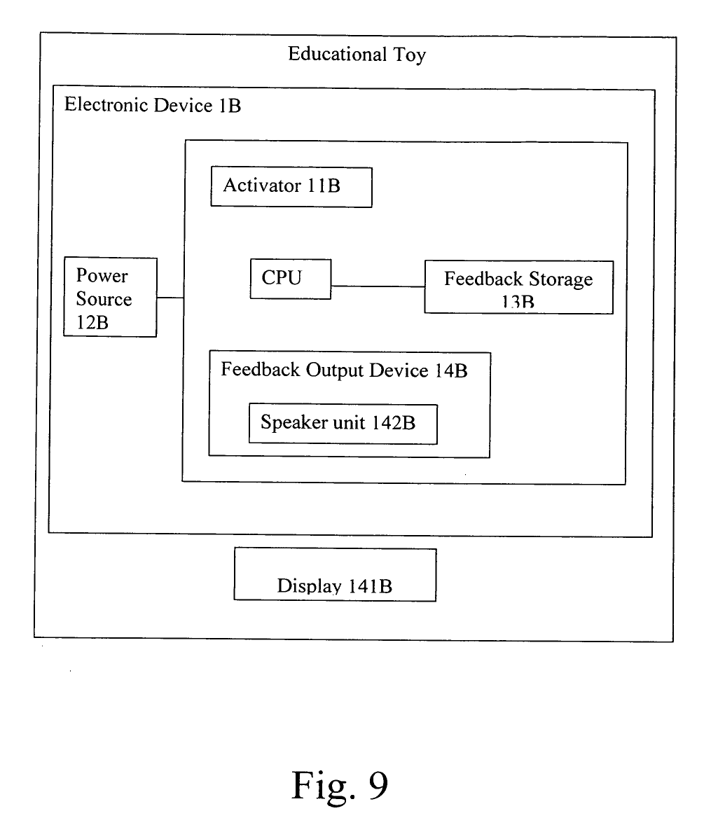

Referring to FIGS. 7 to 9, an educational toy according to a third preferred embodiment of the present invention is illustrated, wherein the educational toy comprises an electronic device 1B and a toy body 2B. The electronic device 1B comprises an activator 11B, a power source 12B to provide a power for the electronic device 1B, a feedback storage 13B, and an feedback output device 14B operatively or electrically connected to a CPU of the electronic device 1B, so that when the activator 11B is being activated through an interaction between the children and the educational toy, the feedback storage 13B is triggered to output an feedback from the feedback output device 14B.

The toy body 2B having an approximate hollow ball shape comprises a bottom housing 21B and an upper transparent cover 22B, wherein the bottom housing 21B has an approximate hollow half ball shape to define a first compartment 211B therewithin, wherein a bottom of the bottom housing 21B has a small flat surface provided for standing the educational toy on a surface such as floor or table. The transparent cover 22B of the toy body 2B has an approximate hollow half ball shape to define a second compartment 222B therewithin, wherein the transparent cover 22B has an approximate identical shape of the bottom housing 21B, so that the bottom housing 21B and the transparent cover 22B of the toy body 2B are mounted together to form the hollow ball shape of the toy body 2B.

The feedback output device 14B comprises an auditory feedback output device comprising a speaker unit 142B for outputting an auditory feedback, and a visual output arrangement having a display 141B. The display 141B has a figure provided thereon, wherein the figure is an information corresponding to the auditory feedback, such that when the educational toy is being activated through an interaction such as a push from the children, the auditory feedback is being outputted from the speaker unit 142B of the feedback output device 14B, which is related to the figure on the display 141B, in such a manner that the visual figure on the display 141B and the corresponding auditory feedback can educate the children.

An example of the feedback would be a figure of letter “A” showed on the display 141B. When the educational toy is being activated through the interaction, such as pushing, touching, hugging, swinging, or any other movement, which can activate a switch of the activator 11B, a voice “A” is being audibly outputted from the speaker unit 142B, in such manner that the children can learn the letter “A” and its pronunciation.

Another example is a figure of “tree” showed on the display 141B. When the educational toy is being activated through the interaction, such as pushing, touching, hugging, swinging, or any other movement, which can activate the switch of the activator 11B, a voice “tree” is being audibly outputted from the speaker unit 142B, in such manner that the children is capable of learning the object “tree” and its pronunciation.

The display 141B is provided between the bottom housing 21B and the transparent cover 22B of the educational toy, wherein the display 141B is covering the first compartment 211B within the bottom housing 21B. The bottom housing 21B of the toy body 2B has a first opening at the top of the bottom housing 21B, and the transparent cover 22B of the toy body 2B has a second opening at the bottom of the transparent cover 22B, wherein the display 141B, which has a circumference slightly smaller than a circumference of the first opening of the bottom housing 21B, is mounted at an inner peripheral edge of the bottom housing 21B to cover the first compartment 211B of the bottom housing 21B and to form a half ball shape, so as to cover the electronic device 1B provided within the first compartment 211B of the bottom housing 21B.

It is worth mentioning that the display 141B, having a flat surface for printing or coupling the figure on the display 141B, has a size and shape geographically matching the top opening of the first opening of the bottom housing 21B, so that the display 141B has the shape which is identical to a central sectional ball shape.

The toy body 2B further comprises a utility panel 25B supported at a position to partition between the bottom housing 21B and the transparent cover 22B, wherein the visual output device supports on the utility panel 25B and faces towards the transparent cover 22B. The display 141B is supported on a utility surface 23B of the toy body 2B and electrically connected to the electronic device 1, wherein the utility surface 23B is formed on the utility panel 25B at a horizontal position within the transparent cover 22B such that the visual feedback is adapted for being seen through the transparent cover 22B of the toy body 2B to interact with the auditory feedback.

The electronic device 1B is being hosted within the first compartment 211B, wherein the transparent cover 22B is further mounted with a peripheral edge of the first opening of the bottom housing 21B through a peripheral edge of the second opening of the bottom housing 21B, so that the approximate hollow ball shape of the toy body 2B is formed. In order words, the display 141B is being sandwiched between the bottom housing 21B and the transparent cover 22B.

The transparent cover 22B of the toy body 2B further has a plurality of cavities 221B provided at the peripheral edge closed to the first or second opening, and preferably at the peripheral edge of the second opening of the transparent cover 22B, wherein the cavities 221B have different shapes such as triangle, square, and circle, so that the auditory feedback from the feedback output device 14B is being outputted through the cavities 221B. It is worth mentioning that the transparent cover 22B of the toy body 2B is made by a transparent material, so that through the transparent cover 22B, the figure on the display 141B is able to be seen by the children.

The activator 11B of the electronic device 1B is being triggered by the interaction between the children and the educational toy, wherein the interaction is a movement of the educational toy, such as rotating, pushing, moving, shaking, touching, or swinging, so that when the educational toy is triggered by the movement of the interaction, the feedback storage 13B is activated to output the feedback through the feedback output device 14B.

A weight member 212B is further provided at the bottom of the first compartment 21B of the bottom housing 21B as a center of gravity, so that the educational toy can be standing still after being pushed as a roly-poly tumbler.

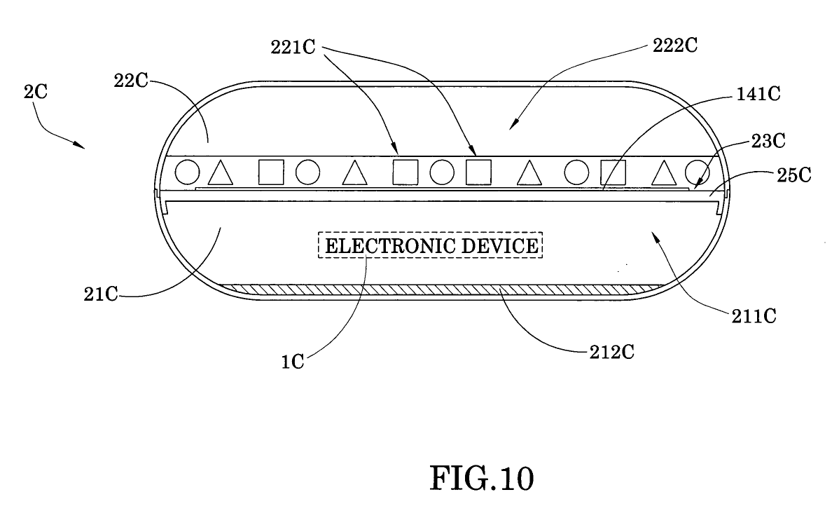

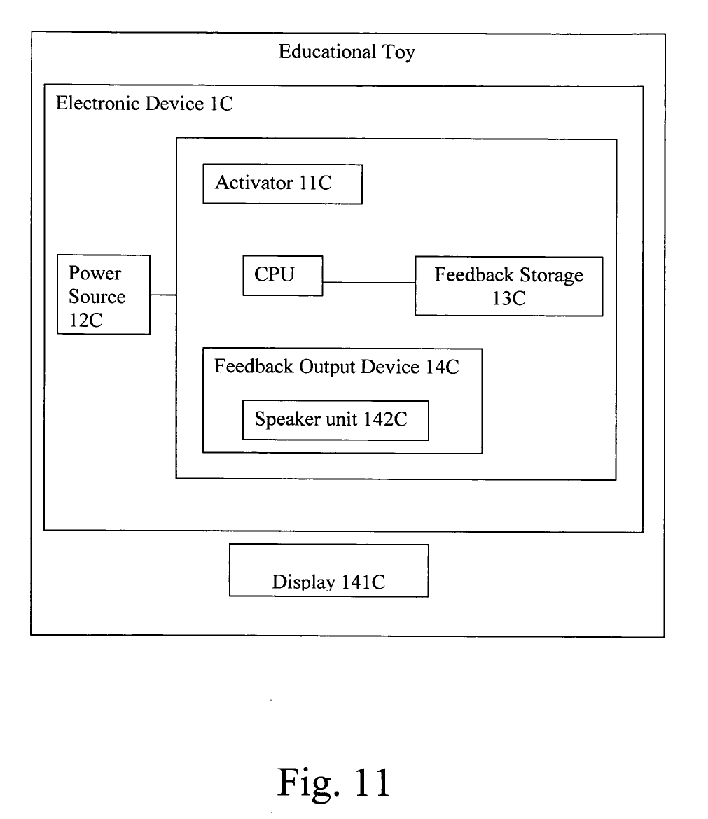

Referring to FIGS. 10 and 11, a fourth preferred embodiment of the present invention is illustrated, wherein the educational toy comprises an electronic device 1C and a toy body 2C. The electronic device 1C comprises an activator 11C, a power source 12C to provide a power for the electronic device 1C, a feedback storage 13C, and an feedback output device 14C operatively or electrically connected to a CPU of the electronic device 1C, so that when the activator 11C is being activated through an interaction between the children and the educational toy, the feedback storage 13C is triggered to output an feedback from the feedback output device 14C.

The toy body 2C having an approximate hollow capsule shape comprises a bottom housing 21C and an upper transparent cover 22C, wherein the bottom housing 21C has an approximate hollow half capsule shape to define a first compartment 211C therewithin, wherein a bottom of the bottom housing 21C has a small flat surface provided for standing the educational toy on a surface such as floor or table. The transparent cover 22C of the toy body 2C has an approximate hollow half capsule shape to define a second compartment 222C therewithin, wherein the transparent cover 22C has an approximate identical shape of the bottom housing 21C, so that the bottom housing 21C and the transparent cover 22C of the toy body 2C are mounted together to form the hollow capsule shape of the toy body 2C.

The feedback output device 14C comprises an auditory feedback output device comprising a speaker unit 142C for outputting an auditory feedback, and a visual output arrangement having a display 141C. The display 141C has a figure provided thereon, wherein the figure is an information corresponding to the auditory feedback, such that when the educational toy is being activated through an interaction such as a push from the children, the auditory feedback is being outputted from the speaker unit 142C of the feedback output device 14C, which is related to the figure on the display 141C, in such a manner that the visual figure on the display 141C and the corresponding auditory feedback can educate the children.

The toy body 2C further comprises a utility panel 25C supported at a position to partition between the bottom housing 21C and the transparent cover 22C, wherein the visual output device supports on the utility panel 25C and faces towards the transparent cover 22C. The display 141C is supported on a utility surface 23C of the toy body 2C and electrically connected to the electronic device 1C, wherein the utility surface 23C is formed on the utility panel 25C at a horizontal position within the transparent cover 22C such that the visual feedback is adapted for being seen through the transparent cover 22C of the toy body 2C to interact with the auditory feedback.

An example of the feedback would be a figure of letter “A” showed on the display 141C. When the educational toy is being activated through the interaction, such as pushing, touching, hugging, swinging, or any other movement, which can activate a switch of the activator 11C, a voice “A” is being audibly outputted from the speaker unit 142C, in such manner that the children can learn the letter “A” and its pronunciation.

Another example is a figure of “tree” showed on the display 141C. When the educational toy is being activated through the interaction, such as pushing, touching, hugging, swinging, or any other movement, which can activate the switch of the activator 11C, a voice “tree” is being audibly outputted from the speaker unit 142C, in such manner that the children is capable of learning the object “tree” and its pronunciation.

The display 141C is provided between the bottom housing 21C and the transparent cover 22C of the educational toy, wherein the display 141C is covering the first compartment 211C within the bottom housing 21C. The bottom housing 21C of the toy body 2C has a first opening at the top of the bottom housing 21C, and the transparent cover 22C of the toy body 2C has a second opening at the bottom of the transparent cover 22C, wherein the display 141C, which has a circumference slightly smaller than a circumference of the first opening of the bottom housing 21C, is mounted at an inner peripheral edge of the bottom housing 21C to cover the first compartment 211C of the bottom housing 21C and to form a half capsule shape, so as to cover the electronic device 1C provided within the first compartment 211C of the bottom housing 21C.

It is worth mentioning that the display 141C, having a flat surface for printing or coupling the figure on the display 141C, has a size and shape geographically matching the top opening of the first opening of the bottom housing 21C, so that the display 141C has the shape which is identical to a longitudinal sectional capsule shape.

The electronic device 1C is being hosted within the first compartment 211C, wherein the transparent cover 22C is further mounted with a peripheral edge of the first opening of the bottom housing 21C through a peripheral edge of the second opening of the bottom housing 21C, so that the approximate hollow capsule shape of the toy body 2C is formed. In order words, the display 141C is being sandwiched between the bottom housing 21C and the transparent cover 22C.

The transparent cover 22C of the toy body 2C further has a plurality of cavities 221C provided at the peripheral edge close to the first or second opening, and preferably at the peripheral edge of the second opening of the transparent cover 22C, wherein the cavities 221C have different shapes such as triangle, square, and circle, so that the auditory feedback from the feedback output device 14C is being outputted through the cavities 221C. It is worth mentioning that the transparent cover 22C of the toy body 2C is made by a transparent material, so that through the transparent cover 22C, the figure on the display 141C is able to be seen by the children.

The activator 11C of the electronic device 1C is being triggered by the interaction between the children and the educational toy, wherein the interaction is a movement of the educational toy, such as rotating, pushing, moving, shaking, touching, or swinging, so that when the educational toy is triggered by the movement of the interaction, the feedback storage 13C is activated to output the feedback through the feedback output device 14C.

A weight member 212C is further provided at the bottom of the first compartment 21C of the bottom housing 21C as a center of gravity, so that the educational toy can be standing still after being pushed as a roly-poly tumbler.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An educational toy for toddler, comprising:
a toy body having at least a compartment therein, wherein said toy body is adapted for providing a playing movement manipulated by said toddler to keep said toddler entertained in an inquisitive manner; and
an electronic device received in said compartment of said toy body, comprising:
an activator being triggered in responsive to said playing movement of said toy body; and
a feedback output device operatively linked to said activator and arranged in such a manner that when said activator is triggered by said playing movement, said feedback output device is adapted for generating a AV feedback as an interactive response of said playing movement to keep said toddler mentally stimulated in an activity he or she naturally enjoys.

2. The educational toy, as recited in claim 1, wherein said AV feedback comprises an auditory feedback and a visual feedback in responsive to said auditory feedback for interactively providing a learning information to said toddler during playing said toy body.

3. The educational toy, as recited in claim 2, wherein said feedback output device comprises an auditory output device supported within said toy body for generating said auditory feedback, and a visual output device providing said visual feedback for being seen through said toy body to interact with said auditory feedback.

4. The educational toy, as recited in claim 3, wherein said toy body comprises a bottom housing for housing said electronic device therein, an upper transparent cover mounted on said bottom housing for said visual feedback being seen through said transparent cover, and a utility panel supported at a position to partition between said bottom housing and said transparent cover.

5. The educational toy, as recited in claim 4, wherein said visual output device supports on said utility panel and faces towards said transparent cover.

6. The educational toy, as recited in claim 1, wherein said toy body has a spherical shape bottom and a weight member disposed therein to provide a center of gravity to ensure said toy body being capable of standing still after being pushed as a tumbler to provide said playing movement.

7. The educational toy, as recited in claim 3, wherein said toy body has a spherical shape bottom and a weight member disposed therein to provide a center of gravity to ensure said toy body being capable of standing still after being pushed as a tumbler to provide said playing movement.

8. The educational toy, as recited in claim 5, wherein said toy body has a spherical shape bottom and a weight member disposed therein to provide a center of gravity to ensure said toy body being capable of standing still after being pushed as a tumbler to provide said playing movement.

9. The educational toy, as recited in claim 1, wherein said activator comprises a motion sensor disposed within said toy body for detecting said playing movement of said toy body so as to activate said feedback output device.

10. The educational toy, as recited in claim 5, wherein said activator comprises a motion sensor disposed within said toy body for detecting said playing movement of said toy body so as to activate said feedback output device.

11. The educational toy, as recited in claim 8, wherein said activator comprises a motion sensor disposed within said toy body for detecting said playing movement of said toy body so as to activate said feedback output device.

12. The educational toy, as recited in claim 2, wherein said visual feedback is a visual image selected from the group consisting of picture, still image, moving image, and light effect, wherein said auditory feedback is a voice effect to describe said visual image.

13. The educational toy, as recited in claim 8, wherein said visual feedback is a visual image selected from the group consisting of picture, still image, moving image and light effect, wherein said auditory feedback is a voice effect to describe said visual image.

14. The educational toy, as recited in claim 11, wherein said visual feedback is a visual image selected from the group consisting of picture, still image, moving image, and light effect, wherein said auditory feedback is a voice effect to describe said visual image.

15. The educational toy, as recited in claim 2, wherein said electronic device further comprises a plurality of selection buttons provided at said toy body to electrically link with said feedback output device for selecting one of said learning information of said AV feedback to be output.

16. The educational toy, as recited in claim 8, wherein said electronic device further comprises a plurality of selection buttons provided at said toy body to electrically link with said feedback output device for selecting one type of said AV feedback to be output.

17. The educational toy, as recited in claim 14, wherein said electronic device further comprises a plurality of selection buttons provided at said toy body to electrically link with said feedback output device for selecting one type of said AV feedback to be output.

18. A method for interactively teaching a toddler by an educational toy which comprises a toy body receiving an electronic device therein, comprising the steps of:
(a) providing a playing movement of said toy body when said toy body is manipulated by said toddler to keep said toddler entertained in an inquisitive manner;
(b) activating said electronic device in responsive to said playing movement of said toy body; and
(c) generating a AV feedback as an interactive response of said playing movement to keep said toddler mentally stimulated in an activity he or she naturally enjoys.

19. The method, as recited in claim 18, wherein the step (c) comprises a step of generating an auditory feedback and a visual feedback in responsive to said auditory feedback for interactively providing a learning information to said toddler during playing said toy body.

20. The method, as recited in claim 19, wherein said visual feedback is a visual image selected from the group consisting of picture, still image, moving image, and light effect, wherein said auditory feedback is a voice effect to describe said visual image.

21. The method as recited in claim 18 wherein, in the step (a), said toy body has a spherical shape bottom and a weight member disposed therein to provide a center of gravity to ensure said toy body being capable of standing still after being pushed as a tumbler to provide said playing movement.

22. The method as recited in claim 20 wherein, in the step (a), said toy body has a spherical shape bottom and a weight member disposed therein to provide a center of gravity to ensure said toy body being capable of standing still after being pushed as a tumbler to provide said playing movement.

23. The method as recited in claim 18 wherein, in the step (b), said electronic device is activated by a motion sensor in responsive to said playing movement of said toy body.

24. The method as recited in claim 22 wherein, in the step (b), said electronic device is activated by a motion sensor in responsive to said playing movement of said toy body.

25. The method, as recited in claim 19, further comprising a step of selecting one of said learning information of said AV feedback to be output through a plurality of selection buttons provided at said toy body.

26. The method, as recited in claim 24, further comprising a step of selecting one of said learning information of said AV feedback to be output through a plurality of selection buttons provided at said toy body.
